(19) United States
(12) Patent Application Publication
(10) Pub. No.: US 2021/0263881 A1
(43) Pub. Date: Aug. 26, 2021

(54) COMPUTER SYSTEM AND METHOD OF OPERATING A COMPUTER SYSTEM

(71) Applicants: Alexander Jäger, Eckental (DE); Werner Körber, Eckental (DE)

(72) Inventors: Alexander Jäger, Eckental (DE); Werner Körber, Eckental (DE)

(73) Assignee: HEITEC AG, Eckental (DE)

(21) Appl. No.: 17/179,834

(22) Filed: Feb. 19, 2021

(30) Foreign Application Priority Data
Feb. 21, 2020 (DE) 102020104585.9

(51) Int. Cl. G06F 13/42

(52) U.S. Cl. CPC G06F 13/4282; G06F 2213/0026

(57) ABSTRACT

A computer system, including a computing module, a communication module, and at least one I/O interface is described. The computing module includes a COM Express module and/or a COM HPC module. The communication module includes a SMARC module and/or a Qseven module. The communication module has an FPGA module which is connected in a signal-transmitting manner to the computing module and to the at least one I/O interface. The FPGA module is configured to communicate with the computing module based on at least one first communication standard, and to communicate with the at least one I/O interface based on at least one second communication standard. The FPGA module is configured to convert signals from the least one first communication standard to the at least one second communication standard and vice versa. The computing module is configured as a host, and the communication module is configured as a client. A method of operating a computer system is furthermore described.

### TECHNICAL FIELD

Embodiments of the present disclosure generally relate to a computer system. Further, embodiments of the present disclosure relate to a method of operating a computer system.

### BACKGROUND

In many fields of industry, commercial business and passenger transport, computer systems are used which are also referred to as “embedded systems” in the English language.

These computer systems are usually specifically tailored to a certain application and comprise the components and interfaces necessary for this specific application.

On the one hand, this is advantageous as the computer power, the storage capacities and the interfaces are exactly tailored to the desired application, as a result of which it is possible to avoid excess computing resources and save costs.

On the other hand, embedded computer systems known from the prior art have the disadvantage that they are hardly adapted or even not adapted at all to be retrofitted if the requirements on the computer power and/or the interfaces change.

Therefore, the object is to provide a computer system permitting a simple retrofitting and/or a backfitting of components.

### SUMMARY

The present disclosure provides examples of a computer system, including a computing module comprised of one or more circuits, a communication module comprised of one or more circuits, and at least one I/O interface. The computing module comprises a COM Express module comprised of one or more circuits and/or a COM HPC module comprised of one or more circuits. The communication module comprises a SMARC module comprised of one or more circuits and/or a Qseven module comprised of one or more circuits. In an embodiment, the communication module has an FPGA circuit or module which is connected in a signal-transmitting manner to the computing module and to the at least one I/O interface. The FPGA module is configured to communicate with the computing module based on at least one first communication standard, and to communicate with the at least one I/O interface based on at least one second communication standard. The FPGA module is configured to convert signals from the least one first communication standard to the at least one second communication standard and vice versa.

The computer system is based on the idea to combine the advantages of the COM Express or the COM HPC standard, on the one hand, and the advantages of the SMARC or Qseven standards, on the other hand.

The computing module distinguishes itself by the ability of a simple retrofitting of the computing and storage components, for example of CPUs, GPUs and/or working storage due to the COM Express or COM HPC standard.

In contrast thereto, the communication module distinguishes itself by a high flexibility and by a low current consumption. The high flexibility can be put down, among other things, to the large number of standardly unoccupied and thus freely assignable pins of SMARC or Qseven boards. In other words, many free pins are still available for communication with the I/O interfaces and the computing module.

The communication module, more specifically the FPGA module ensures that the communication between the computing module and the at least one I/O interface functions by converting signals between the at least one first communication standard and the at least one second communication standard.

The communication module is configured as a client and is therefore controlled and monitored by the computing module.

Accordingly, the entire computer system can be adapted very simply to a new set of I/O interfaces by simply reprograming the FPGA module.

In summary, examples of the computer system thus offer the ability of a simple retrofitting of the computing components and also permits a later replacement and/or the addition of I/O interfaces. The computing power of the computer system is thus scalable, and is for example also subsequently scalable. Furthermore, the computer system permits an adaptation of the I/O interfaces to customized requirements.

It should be noted that in the context of the present patent application, only the generic terms as to the individual standards are mentioned for reasons of readability. However, all suitable variations of the respective standard are also always tacitly included. For example, the variants COM Express 1, 2, 3 etc. are combined to the term “COM Express”. COM Express 3.0 is for example also included.

The same applies to the term “SMARC” which for example comprises SMARC 2.0, and to the terms “COM HPC” and “Qseven”.

One aspect provides that the computing module and the communication module are each provided on a separate baseboard or in that the computing module and the communication module are provided on a common baseboard. If the computing module and the communication module are provided on a common baseboard, a computer system is obtained which is particularly compact and specifically requires particularly little installation space. However, if the computing module and the communication module are provided on different baseboards, the individual components can be replaced particularly easily.

In some embodiments, the at least one first communication standard comprises PCI, PCI Express, SPI and/or USB. It should be noted that this includes all versions of these standards, as also indicated above. In some embodiments, the at least one first communication standard comprises at least PCI Express as this standard permits a particularly high data rate, wherein the individual components involved do not interfere with each other.

In some embodiments, the computing module has a first reference oscillator which is configured to generate a first reference clock signal for the computing module, and the communication module has a second reference oscillator which is configured to generate a second reference clock signal for the communication module. Therefore, the computing module and the communication module each generate a separate clock signal on the basis of which they respectively process data. This configuration permits an error-free communication between the computing module and the communication module by PCI Express

In some embodiments, no separate clock signal is transmitted between the computing module and the communication module. The clock lines of the computing module and of the communication module are thus entirely separated from each other.

According to an embodiment, the at least one second communication standard is configured to permit a communication with an m.2 interface, an Ethernet interface, a RS232 interface, a RS422 interface, a RS485 interface, a binary input/output, an odometer, a UART interface, a CAN interface and/or an EtherCAT interface and/or to communicate based on I2C. The listing of these interfaces is to be regarded as purely representative. The at least one second communication standard may of course also be configured to communicate with interfaces different from the mentioned interfaces and/or based on a bus system different from I2C.

According to a further aspect, at least two I/O interfaces are provided which communicate with the FPGA module based on different second communication standards. The FPGA module is accordingly configured to convert signals from the at least one first communication standard to the different second communication standards and vice versa.

It is conceivable that the FPGA module has a separate FPGA per I/O interface.

It is of course also possible to provide one FPGA for several I/O interfaces or that the FPGA module comprises only one FPGA for all I/O interfaces.

The FPGA module may of course also be configured to communicate with the computing module based on at least two different first communication standards. The FPGA module is then configured to convert signals from the at least one second communication standard to the different first communication standards and vice versa.

The computing module for example has an x86 processor. Accordingly, the computing module has a large computing power and can rapidly process large data volumes.

According to another aspect, the communication module has an ARM and/or x86 processor, for example wherein the processor is connected to an Ethernet interface and/or to a USB interface. The ARM processor has a low energy consumption as it is adapted to be switched off component by component. Accordingly, the ARM processor may flexibly be switched on if necessary, if required by the circumstances. In contrast thereto, compared with the ARM processor, the x86 processor offers a higher computing power which is particularly advantageous if the processor is in operation for the major part of time.

The computer system may have at least one wireless circuit or module which is configured to communicate wirelessly, wherein the computing module is connected, for example directly connected in a signal-transmitting manner to the at least one wireless module. The wireless modules are for example a WLAN module, a mobile radio module, an LPWA module, a GPS module, a GSM module, an LTE module etc.

The term “directly connected” means that the computing module is immediately connected to the at least one wireless module via appropriate lines, rather than via the communication module.

A further aspect of the provides that the computer system has a least one data store, wherein the computing module is connected, for example directly connected to the at least one data store. The computing module is for example connected to the at least one data store by SATA, SD bus and/or NVM Express.

The term “directly connected” means that the computing module is immediately connected to the at last one data store via appropriate lines rather than via the communication module.

In some embodiments, the computing module and/or the communication module are/is heat-conductively connected to a housing of the computer system. It is thus ensured that heat from the computing module and from the communication module, for example from processors installed on these modules, is dissipated to the outside via the housing.

Furthermore, it is thus ensured in some embodiments that the computing module and the communication module have the same or at least a similar temperature such that internal reference oscillators of the computing module and of the communication module experience the same thermal drift. Accordingly, there are no frequency offsets of the internal reference oscillators which can be caused by temperature differences.

According to a further aspect, the computing module is configured as a host and the communication module is configured as a client. In other words, the computing module controls and monitors the remaining computer system, for example the communication module.

Further, the present disclosure provides examples of a method of operating a computer system, for example a computer system as described above. The computer system includes a computing module, a communication module, and at least one I/O interface. The computing module comprises a COM Express module and/or a COM HPC module. The communication module comprises a SMARC module and/or a Qseven module. The communication module has an FPGA module which is connected in a signal-transmitting manner to the computing module and the at least one I/O interface. The FPGA module is configured to communicate with the computing module based on at least one first communication standard, and to communicate with the at least one I/O interface based on at least one second communication standard, for example wherein the computing module is configured as a host and the communication module is configured as a client. In an embodiment, the method comprises the following steps:

generating at least one data signal by the computing module based on the at least one first communication standard and/or receiving at least one data signal by the at least one I/O interface based on the at least one second communication standard;

transmitting the at least one data signal to the communication module; and

converting the data signal from the at least one first communication standard to the at least one second communication standard or from the at least one second communication standard to the at least one first communication standard by the FPGA module, as a result of which a converted data signal is generated.

Accordingly, according to a first possibility, the data signal is generated by the computing module and transmitted to the communication module based on the at least one first communication standard. The data signal is then converted by the FPGA module to the at least one second communication standard.

According to a second possibility, the data signal is received via the at least one I/O interface and transmitted to the communication module based on the at least one second communication standard. The data signal is then converted by the FPGA module to the at least one first communication standard.

In view of the advantages and properties of the method of operating the computer system, reference is made to the above explanations as to the computer system, which also apply to the method and vice versa.

In some embodiments, the converted data signal is transmitted to the at least one I/O interface or the computing module. After conversion of the data signal, it is thus transmitted to the computing module for a further processing if the original data signal has been received via the at least one I/O interface. If the data signal has been generated by the computing module, the converted data signal is transmitted for output to the at least one I/O interface, for example only to one or to several specific I/O interfaces for which the data signal is intended.

One aspect provides that the data signal is transmitted between the computing module and the communication module via PCI Express. This standard permits an exchange of data at a particularly high data rate, wherein the individual components involved do not interfere with each other.

In some embodiments, the computing module and the communication module each generate a separate reference clock signal on the basis of which they each process data. This configuration permits an error-free communication between the computing module and the communication module by PCI Express.

According to another aspect, no separate clock signal is transmitted between the computing module and the communication module. The clock lines of the computing module and of the communication module are thus entirely separated from each other.

In some embodiments, the term “module,” “unit,” “interface” refers to or includes, inter alia, a combination of hardware (e.g. a processor such as an integrated circuit or other circuitry) and software (e.g. machine- or processor-executable instructions, commands, or code such as firmware, programming, or object code). Furthermore, a combination of hardware and software may include hardware only (i.e. a hardware element with no software elements), software hosted at hardware (e.g. software that is stored at a memory and executed or interpreted at a processor), or hardware with the software hosted thereon. In some embodiments, the hardware may, inter alia, comprise a CPU, a GPU, an FPGA, an ASIC, or other types of electronic circuitry.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows an oblique view of a computer system according to an embodiment of the disclosure;

FIG. 2 schematically shows a block diagram of the computer system according to FIG. 1;

FIG. 3 schematically shows a further block diagram of the computer system according to FIG. 1;

FIG. 4 shows a block diagram of a representative computing module and of a representative communication module of the computer system according to FIG. 1;

FIG. 5 shows a flow chart of a method according to the disclosure of operating a computer system;

FIG. 6 shows a further flow chart of a representative method according to the disclosure; and

FIG. 7 shows a cross-section through the computer system according to FIG. 1.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

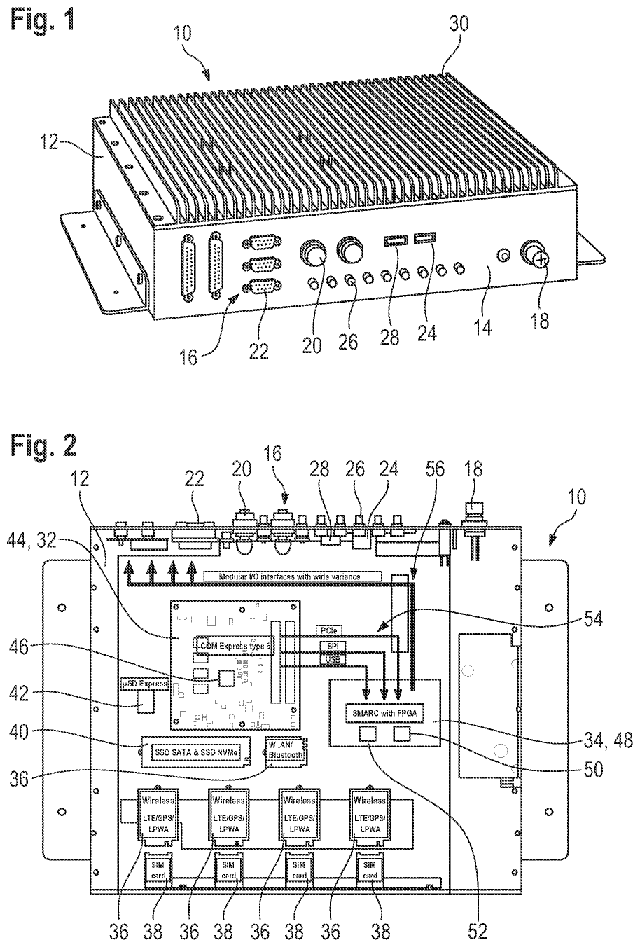

FIG. 1 schematically shows a computer system 10. In general terms, the computer system 10 is a system which is also referred to as “embedded system” in English language. The computer system 10 is for example used in the industry, in commercial business, in passenger transport, for example in trains, and/or in medical applications. The computer system complies, for example, with EN50155 and is thus suitable for use in railway vehicles.

The computer system 10 includes a housing 12 which, for example, entirely surrounds the electronic components of the computer system 10. In an embodiment, the housing has a front side 14 at which a plurality of I/O interfaces 16 and a power connection plug 18 are provided. In the example shown in FIG. 1, the I/O interfaces 16 comprise, among others, Ethernet interfaces 20, RS232, RS422 and/or RS485 interfaces 22, a USB interface 24, antenna ports 26 and a DisplayPort interface 28.

However, is should be noted that the configuration of I/O interfaces 16 shown in FIG. 1 is purely representative. The I/O interfaces 16 may for example vary depending on the customer requirement or the field of application of the computer system 10, and may exactly be tailored thereto.

Optionally, cooling ribs 30 which improve the heat exchange between the computer system 10 and the environment may be provided on a further side of the housing 12, for example on an upper side.

FIG. 2 schematically shows a cross-section through the computer system 10, wherein the individual components within the housing 12 are represented in the form of a block diagram. The computer system includes a computing module 32 comprised of one or more circuits, a communication module 34 comprised of one or more circuits, a plurality of wireless modules 36 comprised of one or more circuits, SIM modules 38 comprised of one or more circuits, and a first data store 40 and a second data store 42.

The SIM modules 38 are respectively assigned to at least one of the wireless modules 36. The SIM modules 38 can each accommodate a SIM card to unambiguously identify the computer system 10 for mobile radio and/or GPS.

In the example embodiment shown in FIG. 2, the computing module 32 comprises a COM Express module 44 having an x86 processor 46. Alternatively or additionally, the computing module 32 may also comprise a COM HPC module.

The communication module 34 comprises a SMARC module 48 having an FPGA module 50. The FPGA module 50 comprises one or more FPGAs connected to the I/O interfaces 16. Optionally, the communication module 34 may have a processor 52 based on ARM or x86 which may be connected to further USB interfaces and/or Ethernet interfaces. Several processors which are respectively based on ARM or x86 may also be provided on the communication module 34. Alternatively or additionally, the communication module 34 may also comprise a Qseven module.

In the example embodiment shown in FIG. 2, the computing module 32 and the communication module 34 are each arranged on a separate baseboard. Alternatively, the computing module 32 and the communication module 34 can however also be arranged on a common baseboard. However, the computing module 32 and the communication module 34 are in both cases heat-conductively connected to the housing 12, such that excess heat is dissipated. Therefore, the computing module 32 and the communication module 34 are for example kept at the same temperature.

The computing module 32 and the communication module 34 are connected to each other in a signal-transmitting manner, which is indicated by the arrows 54 in FIG. 2. The computing module 32 and the communication module 34 are configured to communicate with each other based on at least one first communication standard. Accordingly, data signals are transmitted between the computing module 32 and the communication module 34 based on the at least one first communication standard. More specifically, the data signals are transmitted between the computing module 32 and the FPGA module 50 based on the at least one first communication standard.

The at least one first communication standard comprises, for example, PCI Express, SPI and/or USB. Alternatively or additionally, the at least one first communication standard may also include further suitable standards.

The communication module 34 is in turn connected in a signal-transmitting manner to the I/O interfaces 16, which is represented by the arrows 56 in FIG. 2. The communication module 34 is configured to communicate with the I/O interfaces 16 based on at least one second communication standard. Accordingly, data signals are transmitted between the communication module and the I/O interfaces 16 based on the at least one second communication standard. More specifically, the data signals are transmitted between the FPGA module 50 and the I/O interfaces 16 based on the at least one second communication standard.

The at least one second communication standard is configured to enable communication of the FPGA module 50 with the specific I/O interfaces 16 of the computer system 10. As the computer system 10 has different I/O interfaces 16, the FPGA module 50 is configured to communicate with the respective I/O interface 16 based on the respectively appropriate second communication standard.

In the example embodiment shown in FIG. 2, the at least one second communication standard enables for example communication between the FPGA module 50 and the Ethernet interfaces 20, the RS232/RS422/RS485 interfaces 22, the USB interface 24, the antenna ports 26 and the DisplayPort interface 28.

The FPGA module 50 is thus configured to communicate with the computing module 32 based on the at least one first communication standard and with the I/O interfaces 16 based on the at least one second communication standard. To enable communication of the computing module 32 and the I/O interfaces 16, the FPGA module 50 is configured to convert signals from the at least one first communication standard to the at least one second communication standard, and vice versa.

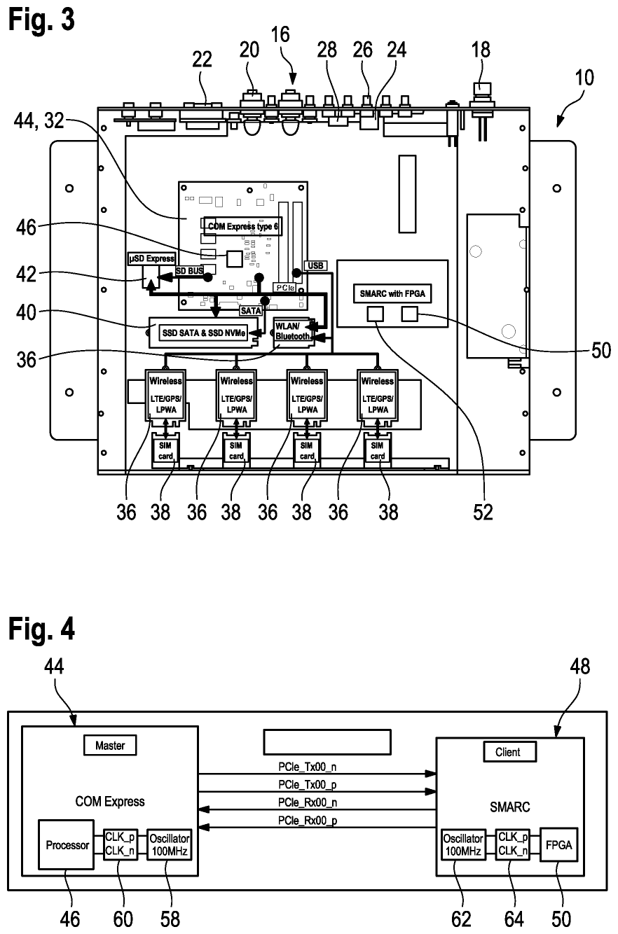

FIG. 3 illustrates the signal-transmitting connections between the computing module 32, on the one hand, and the wireless modules 36, the first data store 40 and the second data store 42, on the other hand. In the example embodiment shown there, the wireless modules 36 are connected to the computing module 32 by USB and/or PCI Express. The first data store 40 is connected to the computing module 32 by SATA and/or PCI Express. The second data store 42 is connected to the computing module 32 by SD bus and/or PCI Express.

FIG. 4 illustrates the configuration of the PCI Express connection between the computing module 32 and the communication module 34. In this embodiment, the computing module 32, more specifically the COM Express module 44, is configured as a host, while the communication module 34, more specifically the SMARC module is configured as a client. In other words, the computing module 32 can control the communication module 34. The same also applies if the computing module 32 comprises a COM HPC module and/or if the communication module 34 comprises a Qseven module.

The PCI Express connection is configured as described below to permit this configuration, i.e. COM Express module 44 as a host and SMARC module 48 as a client.

In an embodiment, the computing module 32 has a first reference oscillator 58 which is configured to generate a first reference clock signal 60 for the computing module 32, more specifically for the x86 processor 46. The communication module 34 has a second reference oscillator 62 which is configured to generate a second reference clock signal 64 for the communication module 34, more specifically for the FPGA module 50. The computing module 32 and the communication module 34 thus include clock signal paths which are separated from each other. Accordingly, no separate clock signal is transmitted between the computing module 32 and the communication module 34, at least for the PCI Express connection.

The frequencies of the first reference clock signal 60 and the second reference clock signal 64 are identical. “Identical” means that the frequency of the reference clock signals 60, 64 respectively deviates from a predefined clock frequency by a maximum of ±300 ppm, as is also defined in the PCI Express standard.

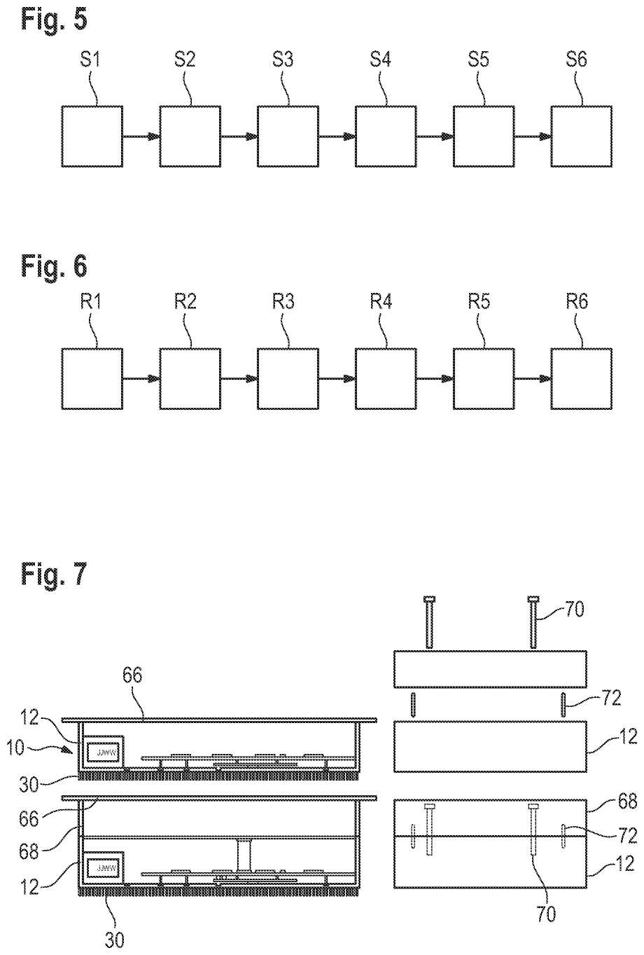

In the example shown in FIG. 4, the frequency of the first reference oscillator 58 and of the second reference oscillator 62 is respectively 100 MHz. The computer system 10 is configured to perform the representative method described below with reference to FIG. 5.

At first, the computing module 32 receives a data signal from at least one of the wireless modules 36, from the first data store 40 and/or from the second data store 42 (step S1).

The data signal is processed by the x86 processor 46 based on the first reference clock signal 60, as a result of which a processed data signal is generated (step S2).

The processed data signal is then transferred to the communication module 34, more specifically to the FPGA module 50 based on the at least one first communication standard (step S3).

As already explained above, no separate clock signal is transmitted between the computing module 32 and the communication module 34. Therefore, the communication module 34, more specifically the FPGA module 50 performs a clock recovery to further process the data signal (step S4).

During the clock recovery, the clock, i.e. the symbol rate of the data signal is determined based on the data signal. The symbol rate may quite be different from the frequency of the first reference clock signal 60 and/or the frequency of the second reference clock signal 64.

The FPGA module 50 converts the received data signal based on the second reference clock signal 64 from the at least one first communication standard to the at least one second communication standard, as a result of which a converted data signal is generated (step S5).

More specifically, the FPGA module 50 converts the received data signal to that second communication standard which is related to that I/O interface 16 to which the data signal is to be transmitted.

The converted data signal is then transmitted to that one of the I/O interfaces 16 for which the data signal is intended (step S6). This information may for example be part of the data signal.

The data signal can then be transmitted to further external devices via the I/O interfaces 16.

The method described above corresponds to a signal path which leads from the wireless modules 36, the first data store 40 and/or the second data store 42 via the computing module 32 and the communication module 34 to the I/O interfaces 16.

However, the computer system 10 can of course also receive and process signals via the I/O interfaces 16, which is described below with reference to FIG. 6.

At first, a data signal is received by the I/O interfaces 16 and is transferred to the communication module 34, more specifically to the FPGA module 50 based on the at least one second communication standard (step R1).

The FPGA module 50 converts the received data signal based on the second reference clock signal 64 from the at least one second communication standard to the at least one first communication standard, as a result of which a converted data signal is generated (step R2).

The converted data signal is transmitted to the computing module 32 based on the at least one first communication standard (step R3).

As already explained above, no separate clock signal is transmitted between the communication module 34 and the computing module 32. Therefore, the computing module 32, for example the x86 processor 46 performs a clock recovery to further process the converted data signal (step R4).

The converted data signal is then processed by the computing module 32, more specifically by the x86 processor based on the first reference clock signal 60, as a result of which a processed data signal is generated (step R5).

The processed data signal is then transmitted to at least one of the wireless modules 36, to the first data store 40, and/or to the second data store 42 (step R6).

The processed data signal can accordingly be transmitted to external devices using the wireless modules 36 and/or can be stored on the first data store 40 and/or the second data store 42.

The computing module 32 of the computer system 10 is therefore responsible for data processing, which is why the x86 processor 46 is provided on the computing module 32.

The communication module 34, along with the FPGA module 50, serves as a variable interface which converts data signals such that the computing module 32 can communicate with each of the I/O interfaces 16.

Accordingly, the computer system 10 can also easily be upgraded or retrofitted at a later date. For example, the computer module 32 may be equipped with more powerful hardware without much effort. It is also possible to add new I/O interfaces subsequently or to replace the I/O interfaces 16. In this case, the FPGA module 50 must simply be reprogrammed to adapt it to the new interface configuration.

The computer system 10 described above is therefore adapted to be backfitted or retrofitted in a very flexible way. To improve this flexibility, the housing 12 may be expandable as shown in FIG. 7.

In the left upper part of FIG. 7, the above described computer system 10 is shown in a cross-section. On a side opposite the cooling ribs 30, the housing 12 has a cover 66 which is non-destructively and detachably connected, for example screwed to the housing.

To expand the housing 12, it is possible to remove the cover 66 and to place an expansion module 68 onto the housing 12. Principally, the expansion module 68 may have any height. For example, the expansion module 68 has between 25 and 75 percent of the height of the housing 12, for example 50 percent of the height of the housing 12. The expansion module 68 is connected to the housing 12 by appropriate fastening means, for example by screws 70 and/or fixing pins 72. The cover 66 is then placed onto the expansion module 68 and is connected, for example screwed thereto.

Certain embodiments disclosed herein, for example the respective module(s), utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors or portions thereof and accompanying software, firmware, hardware, and the like.

Various embodiments of the present disclosure or the functionality thereof may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably). Such non-transitory computer-readable storage media include all computer-readable media (including volatile and non-volatile media).\

Embodiments of the present disclosure may also take the form of an apparatus, system, computing device, computing entity, and/or the like executing instructions stored on computer-readable storage media to perform certain steps or operations. The computer-readable media include cooperating or interconnected computer-readable media, which exist exclusively on a processing or processor system or distributed among multiple interconnected processing or processor systems that may be local to, or remote from, the processing or processor system. However, embodiments of the present disclosure may also take the form of an entirely hardware embodiment performing certain steps or operations.

Various embodiments are described above with reference to block diagrams and/or flowchart illustrations of apparatuses, methods, systems, and/or computer program instructions or program products. It should be understood that each block of any of the block diagrams and/or flowchart illustrations, respectively, or portions thereof, may be implemented in part by computer program instructions, e.g., as logical steps or operations executing on one or more computing devices. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein.

These computer program instructions may also be stored in one or more computer-readable memory or portions thereof, such as the computer-readable storage media described above, that can direct one or more computers or computing devices or other programmable data processing apparatus(es) to function in a particular manner, such that the instructions stored in the computer-readable memory produce an article of manufacture including computer-readable instructions for implementing the functionality specified in the flowchart block or blocks.

The computer program instructions may also be loaded onto one or more computers or computing devices or other programmable data processing apparatus(es) to cause a series of operational steps to be performed on the one or more computers or computing devices or other programmable data processing apparatus(es) to produce a computer-implemented process such that the instructions that execute on the one or more computers or computing devices or other programmable data processing apparatus(es) provide operations for implementing the functions specified in the flowchart block or blocks and/or carry out the methods described herein.

It will be appreciated that the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof.

Accordingly, blocks of the block diagrams and/or flowchart illustrations support various combinations for performing the specified functions, combinations of operations for performing the specified functions and program instructions for performing the specified functions. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

According to some embodiments, many individual steps of a process may or may not be carried out utilizing computer or computing based systems described herein, and the degree of computer implementation may vary, as may be desirable and/or beneficial for one or more particular applications.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A computer system, including a computing circuit, a communication circuit, and at least one I/O interface, wherein:
the computing circuit comprises at least one of a COM Express circuit and a COM HPC circuit;
the communication circuit comprises at least one of a SMARC circuit and a Qseven circuit;
the communication circuit has an FPGA circuit which is connected in a signal-transmitting manner to the computing circuit and to the at least one I/O interface;
the FPGA circuit is configured to communicate with the computing circuit based on at least one first communication standard, and to communicate with the at least one I/O interface based on at least one second communication standard; and
the FPGA circuit is configured to convert signals from the least one first communication standard to the at least one second communication standard and vice versa.

2. The computer system according to claim 1, wherein the computing circuit and the communication circuit are each provided on a separate baseboard or in that the computing circuit and the communication circuit are provided on a common baseboard.

3. The computer system according to claim 1, wherein the at least one first communication standard comprises at least one of PCI, PCI Express, SPI and USB.

4. The computer system according to claim 1, wherein the at least one second communication standard is configured to enable communication with at least one of an m.2 interface, an Ethernet interface, a RS232 interface, a RS422 interface, a RS485 interface, a binary input/output, an odometer, a UART interface, a CAN interface and an EtherCAT interface and/or to communicate based on I2C.

5. The computer system according to claim 1, wherein at least two I/O interfaces are provided which communicate with the FPGA circuit based on different second communication standards.

6. The computer system according to claim 1, wherein the computer circuit has an x86 processor.

7. The computer system according to claim 1, wherein the communication circuit has at least one of an ARM processor and/or a x86 processor.

8. The computer system according to claim 7, wherein the processor is connected to at least one of an Ethernet interface and a USB interface.

9. The computer system according to claim 1, wherein the computer system has at least one wireless circuit which is configured to communicate wirelessly, wherein the computing circuit is connected in a signal-transmitting manner to the at least one wireless circuit.

10. The computer system according to claim 1, wherein the computer system has at least one wireless circuit which is configured to communicate wirelessly, wherein the computing circuit is directly connected in a signal-transmitting manner to the at least one wireless circuit.

11. The computer system according to claim 1, wherein the computer system has at least one data store, wherein the computing circuit is connected to the at least one data store.

12. The computer system according to claim 1, wherein the computer system has at least one data store, wherein the computing circuit is directly connected to the at least one data store.

13. The computer system according to claim 1, wherein at least one of the computing circuit and the communication circuit is heat-conductively connected to a housing of the computer system.

14. The computer system according to claim 1, wherein the computing circuit is configured as a host and the communication circuit is configured as a client.

15. A method of operating a computer system that includes a computing circuit, a communication circuit, and at least one I/O interface, wherein the computing circuit comprises at least one of a COM Express circuit and a COM HPC circuit, wherein the communication circuit comprises at least one of a SMARC circuit and a Qseven circuit, wherein the communication circuit has an FPGA circuit which is connected in a signal-transmitting manner to the computing circuit and the at least one I/O interface, wherein the FPGA circuit is configured to communicate with the computing circuit based on at least one first communication standard, and to communicate with the at least one I/O interface based on at least one second communication standard, the method comprising the following steps:
generating at least one data signal by the computing circuit based on the at least one first communication standard and/or receiving at least one data signal by the at least one I/O interface based on the at least one second communication standard;
transmitting the at least one data signal to the communication circuit; and
converting the data signal from the at least one first communication standard to the at least one second communication standard or from the at least one second communication to the at least one first communication standard by the FPGA circuit, as a result of which a converted data signal is generated.

16. The method according to claim 16, wherein the computing circuit is a host and the communication circuit is a client.

17. The method according to claim 16, wherein the converted data signal is transmitted to the at least one I/O interface or to the computing circuit.

18. The method according to claim 16, wherein the data signal is transmitted between the computing circuit and the communication circuit by PCI Express.

19. The method according to claim 18, wherein the computing circuit and the communication circuit each generate a separate reference clock signal on the basis of which they respectively process data.

20. The method according to claim 19, wherein no separate clock signal is transmitted between the computing circuit and the communication circuit.
